(19) United States
(12) Patent Application Publication
(10) Pub. No.: US 2013/0159102 A1
(43) Pub. Date: Jun. 20, 2013

(54) METHOD AND APPARATUS FOR PROVIDING ADVERTISEMENT

(71) Applicants: Keun-seob KIM, Suwon-si (KR); Man-seok KANG, Yongin-si (KR); Sei-kwon KIM, Yongin-si (KR); Seung-soo LEE, Seoul (KR)

(72) Inventors: Keun-seob KIM, Suwon-si (KR); Man-seok KANG, Yongin-si (KR); Sei-kwon KIM, Yongin-si (KR); Seung-soo LEE, Seoul (KR)

(73) Assignee: SAMSUNG ELECTRONICS CO., LTD., Suwon-si (KR)

(21) Appl. No.: 13/615,768

(22) Filed: Sep. 14, 2012

(30) Foreign Application Priority Data
Dec. 20, 2011 (KR) 10-2011-0138491

(51) Int. Cl. G06Q 30/02

(52) U.S. Cl. 705/14.53

(57) ABSTRACT

A method and apparatus for providing an advertisement based on a user input that is input from a touch keypad of a mobile terminal, the method including: extracting a key word from input content based on a predetermined key word table; obtaining an advertisement corresponding to the extracted key word, from a server by using the extracted key word; and providing the advertisement obtained from the server in a predetermined portion of a keypad input area of a screen of the terminal.

### CROSS-REFERENCE TO RELATED PATENT APPLICATION

This application claims priority from Korean Patent Applications No. 10-2011-0138491, field on Dec. 20, 2011, in the Korean Intellectual Property Office, the disclosure of which is incorporated herein in its entirety by reference.

### BACKGROUND

1. Field

The exemplary embodiments relate to a method and apparatus for providing an advertisement in a terminal, and more particularly, to a method and apparatus for providing an advertisement based on a user input that is input from a touch keypad of a mobile terminal.

2. Description of the Related Art

Recently, as wireless networks and wireless mobile communication terminals have been more widely used, the market for advertisements targeted at users of the wireless mobile communication terminals is becoming larger.

However, conventional banner advertisements, which are mainly used by current mobile communication terminals, are limited in their advertising effect. Therefore, the conventional banner advertisements do not sufficiently provide information desired by users and thus are inefficient.

### SUMMARY

The exemplary embodiments provide a key word-based advertisement providing method that is capable of providing an advertisement in real time based on a user input that is input by a user from a mobile terminal.

The exemplary embodiments also provide a key word-based advertisement providing apparatus that is capable of providing an advertisement in real time based on a user input that is input by a user from a mobile terminal.

According to an aspect of the exemplary embodiments, there is provided a method of providing an advertisement in a terminal, the method including: extracting a key word from input content based on a predetermined key word table; obtaining an advertisement corresponding to the extracted key word, from a server by using the extracted key word; and providing the advertisement obtained from the server in a predetermined portion of a keypad input area of a screen of the terminal.

The method further includes, if the advertisement provided in the predetermined portion of the keypad input area is selected, providing detailed information related to the advertisement.

The method further includes obtaining the predetermined key word table from the server by requesting the server to send the predetermined key word table.

The predetermined key word table may be generated by matching a registered advertisement with a specific key word in the server.

The key word may be extracted by comparing the predetermined key word table, which is obtained from the server, with input key content.

The obtaining of the advertisement may include: extracting key words similar to a core key word extracted based on the predetermined key word table; accumulating the extracted key words; requesting the server to send an advertisement that corresponds to the accumulated key words; and receiving the advertisement corresponding to the accumulated key words from the server.

Current location information of the terminal as well as a request for the advertisement corresponding to the accumulated key words may be transmitted to the server.

The key word may be extracted based on content that is input during a predetermined time by a user.

The predetermined portion of the key input area may include an upper portion of a touch keypad input area.

The providing of the advertisement may include: checking whether an advertisement corresponding to accumulated key words, exists; and if the advertisement corresponds to the accumulated key words, exists, providing the advertisement in a predetermined portion of a keypad area.

The providing of the advertisement may include providing detailed information related to the provided advertisement if a click signal for the provided advertisement is received.

In the providing of the advertisement, an advertisement list displayed in an upper portion of a touch keypad may be left or right scrolled.

The server may register an advertisement received from an advertiser, generate a key word table by matching the advertisement with a predetermined key word, transmit the key word table to the terminal according to the terminal's request for the key word table, and transmit a corresponding advertisement to the terminal if a request for an advertisement that corresponds to accumulated key words is received from the terminal.

A current location and advertisement information may be matched with each other if the current location is received from the terminal.

According to another aspect of the exemplary embodiments, there is provided a terminal including: an input device which receives a key signal from a user; a display which displays a touch keypad and an advertisement; a controller which extracts a key word by comparing the key signal input from the user with a predetermined key word table, receives an advertisement corresponds to an extracted key word by using the extracted key word, from the server, and provides the advertisement corresponding to the extracted key word, in a portion of a touch keypad of the display.

The display may include a touch keypad area and an advertisement display area, and the advertisement display area may be displayed in the upper portion of the touch keypad area.

### BRIEF DESCRIPTION OF THE DRAWINGS

The above and other features and advantages of the exemplary embodiments will become more apparent by describing in detail exemplary embodiments thereof with reference to the attached drawings in which:

FIG. 1 illustrates an advertisement system for providing an advertisement, according to an exemplary embodiment;

FIG. 2 is a detailed block diagram of a terminal of FIG. 1;

FIG. 3 illustrates an advertisement provision screen of a terminal according to an exemplary embodiment;

FIG. 4 is a flowchart illustrating a method of providing an advertisement, according to an exemplary embodiment;

FIG. 5 is a flowchart illustrating a method of providing an advertisement in a terminal, according to an exemplary embodiment;

FIG. 6 is a detailed flowchart illustrating a method of providing an advertisement in a terminal, according to an exemplary embodiment;

FIG. 7 illustrates an example in which an advertisement provision is implemented in a terminal, according to an exemplary embodiment; and

FIG. 8 is a flowchart illustrating a method of providing an advertisement from a server, in according to an exemplary embodiment.

### DETAILED DESCRIPTION OF EXEMPLARY EMBODIMENTS

Hereinafter, exemplary embodiments will be described in detail with reference to the accompanying drawings. Expressions such as “at least one of,” when preceding a list of elements, modify the entire list of elements and do not modify the individual elements of the list.

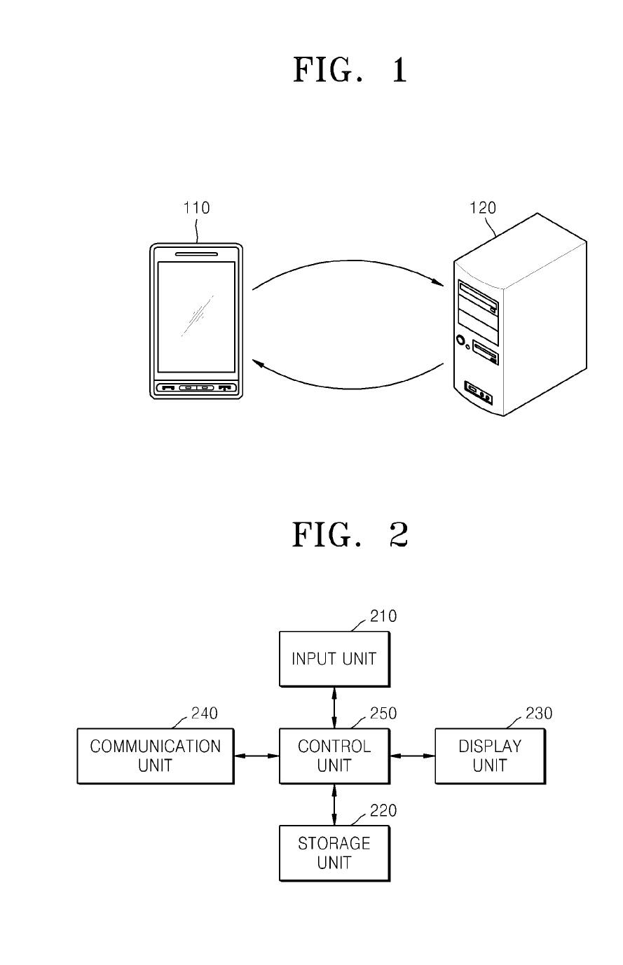

FIG. 1 illustrates an advertisement system for providing an advertisement, according to an exemplary embodiment.

The advertisement system of FIG. 1 includes a terminal 110 and a server 120, which send and receive advertisement data to and from each other through a network.

The terminal 110 includes a keypad application. The server 120 provides advertisement information that is appropriate according to a tendencies of users.

The terminal 110 extracts a key word from key content that is input by a user, obtains an advertisement, which is matched with the extracted key word, from the server 120 by using the extracted key word, and provides the matched advertisement obtained from the server 120 in an upper portion of a keypad of a screen of the terminal 110.

The server 120 acquires an advertisement from an advertiser, then registers the advertisement, and generates a key word table by matching the registered advertisement to a specific key word. In addition, the server 120 transmits the key word table to the terminal 110 according to a request from the terminal 110, and transmits a corresponding advertisement to the terminal 110 if a request for an advertisement that is matched with accumulated key words is received from the terminal 110.

FIG. 2 is a detailed block diagram of the terminal 110 of FIG. 1.

Referring to FIG. 2, the terminal 110 of FIG. 1 includes an input unit 210, a storage unit 220, a display unit 230, a communication unit 240, and a control unit 250.

The input unit 210 may be installed in the display unit 230 in the form of a touch screen, or may be separately formed from the display unit 230 and be installed in a location apart from the display unit 230.

If an input is applied to a touch keypad, the input unit 210 senses the input by detecting a change in a physical quantity due to the input, for example, a change in capacitance etc.

The display unit 230 displays various state information and control commands, which are generated by the control unit 250. The display unit 230 may use a touch screen, but is not limited thereto.

In particular, the display unit 230 includes an input content display area, a keypad area, and an advertisement display area. The advertisement display area may be located in the upper portion of the keypad area and may be adjacent to the upper portion of keypad area or embedded in the upper portion of the keypad area, but is not limited thereto. For example, the advertisement display area may be located in the lower, left, or right portion of the keypad area and may be adjacent to the lower, left, or right portion of keypad area or embedded in the lower, left, or right portion of the keypad area,

The storage unit 220 stores a program or control data for driving the control unit 250 and the key word table.

The storage unit 220 may include an electrical erasable programmable read only memory (EEPROM), a flash memory, or the like, but is not limited thereto.

The communication unit 240 processes wireless communication between the terminal 110 and the server 120. The communication unit may include a transceiver, transmitter, and/or receiver, etc.

The communication unit 240 modulates a signal generated in the control unit 250 into a signal of a desired frequency band and then amplifies the modulated signal, and amplifies a radio frequency (RF) signal received from the server 120 and then demodulates the amplified RF signal into a signal of a desired frequency band.

The control unit 250 (e.g. controller) is formed of an integrated circuit in which several circuits are integrated to implement a microprocessor unit (MPU) or control functions, and performs a function for controlling an overall operation of a mobile terminal, i.e., the terminal 110.

The control unit 250 transmits or receives the advertisement information to or from the server 120 through the communication unit 240, and detects an input signal that is generated in the input unit 210 due to a touch that is applied to the touch keypad.

In particular, the control unit 250 extracts the key word from key content that is input by a user, obtains an advertisement, which is matched with the extracted key word, from the server 120 by using the extracted key word, and provides the matched advertisement obtained from the server 120 in the upper portion of the keypad of the screen of the terminal 110.

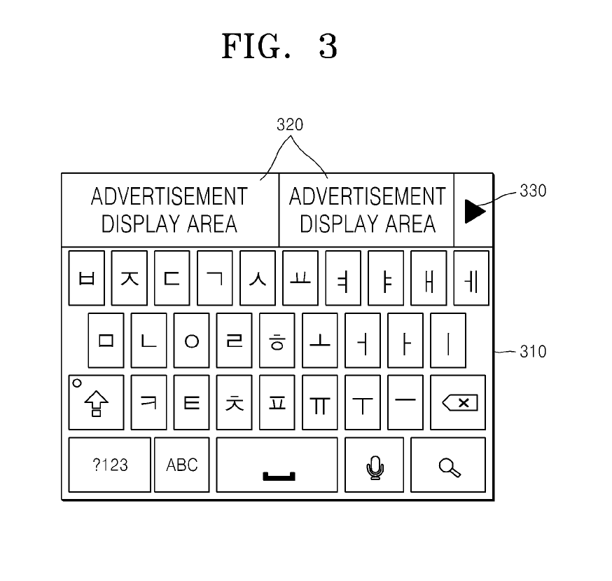

FIG. 3 illustrates an advertisement provision screen of the terminal 110 according to an exemplary embodiment.

Referring to FIG. 3, a touch screen of the terminal 110 includes a keypad area 310, an advertisement display area 320, and a scroll control area 330.

The advertisement display area 320 and the scroll control area 330 may be located in the upper portion of the keypad area 310 for user convenience, but is not limited thereto.

Thus, a user may see an advertisement, which is provided in the advertisement display area 320, while inputting keys in the keypad area 310. In addition, a user may scroll an advertisement list displayed in the advertisement display area 320 by using a scroll key of the scroll control area 330 to see the advertisement list. According to an aspect of an exemplary embodiment, the advertisement list may scrolled up, down, left, and/or right.

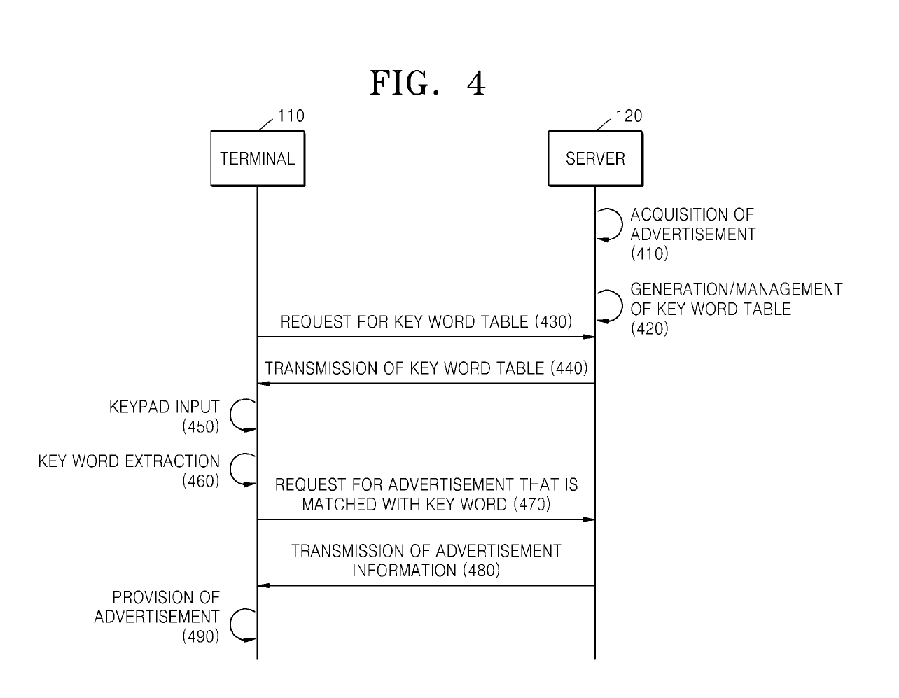

FIG. 4 is a flowchart illustrating a method of providing an advertisement, according to an exemplary embodiment.

First, a server 120 acquires an advertisement from an advertiser (operation 410). In addition, the server 120 generates a key word table by matching the acquired advertisement with a specific key word and then manages the key word table (operation 420). The key word table stores key word data.

During an idle time, a terminal 110 requests the server 120 to send the key word table (operation 430). The idle time means a time during which the terminal is in an available state but not actually used.

Next, the server 120 transmits the key word table to the terminal 110 if a request for the key word table is received from the terminal 110 (operation 440).

Next, the terminal 110 receives key input content of a user from the touch keypad (operation 450).

Next, the terminal 110 extracts a key word by comparing the key input content input from the touch keypad with the key word table (operation 460).

Next, the terminal 110 requests the server 120 to send an advertisement that is matched with the extracted key word (operation 470).

Next, if the server 120 receives a request for the advertisement, the server 120 transmits corresponding advertisement information to the terminal 110 (operation 480).

Finally, the terminal 110 provides the advertisement information received from the server 120 in an upper portion of the touch keypad (operation 490).

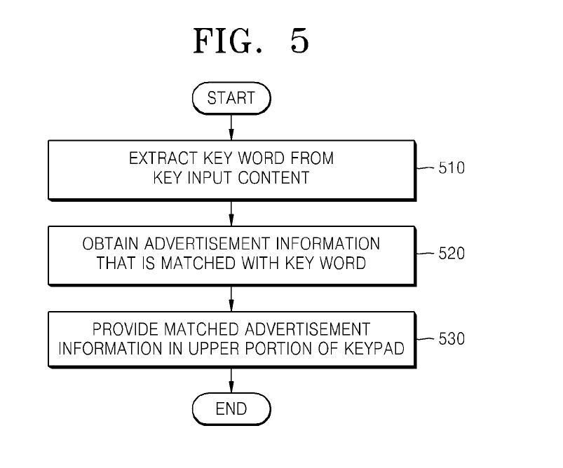

FIG. 5 is a flowchart illustrating a method of providing an advertisement in a terminal, according to an exemplary embodiment.

First, a user inputs content by using a touch keypad installed in the terminal 110.

Next, a key word is extracted by comparing the content input from the touch keypad with a key word table received from the server 120 (operation 510).

Next, an advertisement that is matched with the extracted key word is requested from the server 120, and then the matched advertisement is obtained (operation 520).

Next, the matched advertisement obtained from the server 120 is provided in an upper portion of a keypad area of a touch screen of the terminal 110 (operation 530).

Thus, according to the above exemplary embodiments, it is possible to provide an advertisement in real time based on the tendency of a user depending on content that is input by a user from the terminal 110.

In addition, the advertisement providing method according to the above exemplary embodiments may independently operate in all applications.

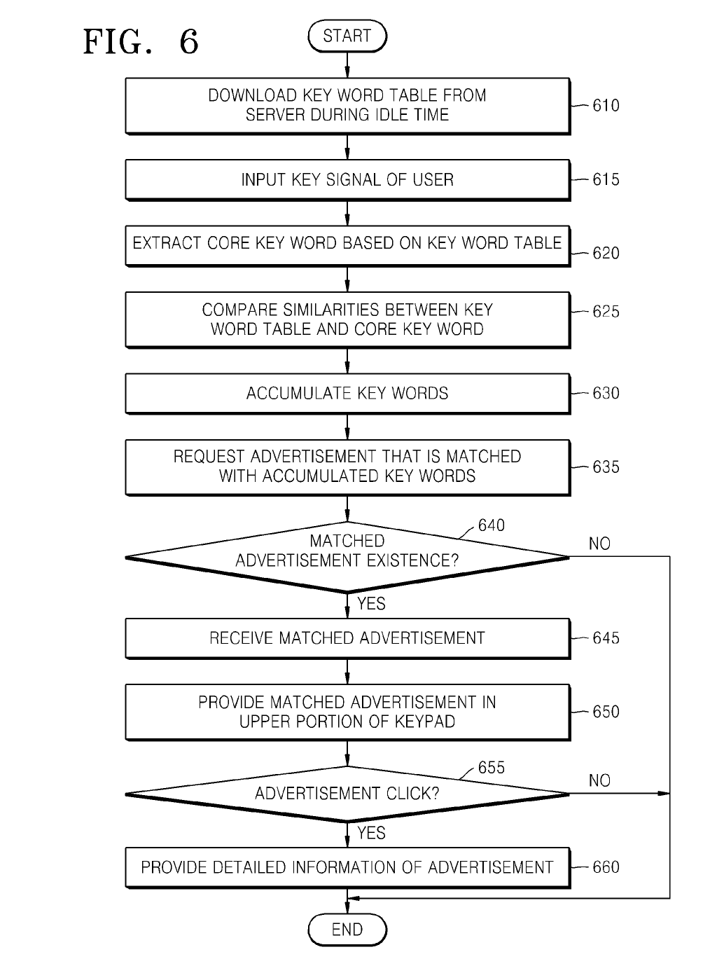

FIG. 6 is a detailed flowchart illustrating a method of providing an advertisement in a terminal, according to an exemplary embodiment.

First, a key word table in which an advertisement and a specific key word are matched with each other is downloaded from the server 120 during an idle time, and the downloaded key word table is synchronized with a key word table of the server 120 (operation 610).

That is, the terminal 110 includes the key word table that is the same as that of the server 120 through the synchronization process. The key word table stores a key word database in which an advertisement obtained from an advertiser is matched with a specific key word. For example, if key words are a movie theater and a restaurant, the key word table stores advertisement information that is matched with the key words, i.e., the movie theater and the restaurant.

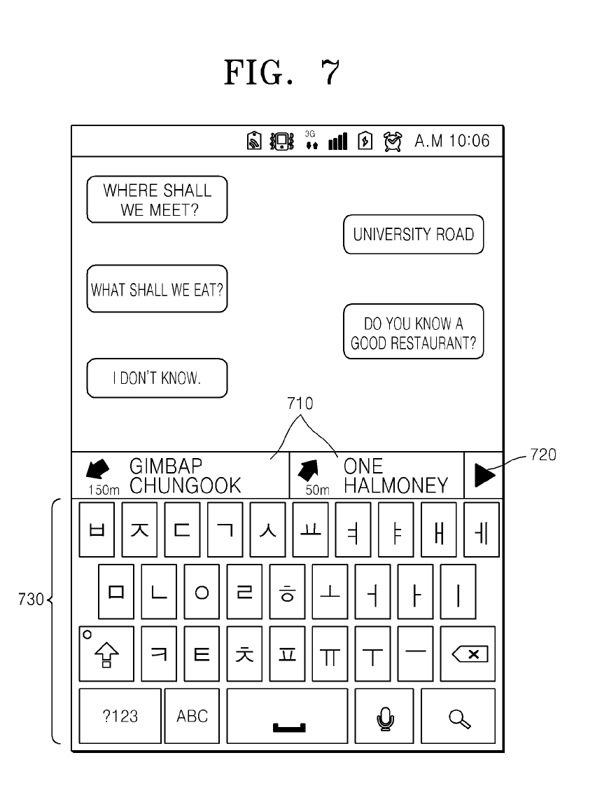

Next, a key signal that is input by a user from a touch keypad is used to analyze the tendency of the user (operation 615). For example, as illustrated in FIG. 7, a user inputs text such as “Where shall we meet?”, “University Road”, “What shall we eat?”, and “Do you know a good restaurant?” by using the touch keypad of a keypad area 730.

Next, a core key word is extracted based on the key word table downloaded from the server 120 (operation 620). For example, “University Road” and “good restaurant” that are core key words are extracted by comparing “Where shall we meet?”, “University Road”, “What shall we eat?”, and “Do you know a good restaurant?”, which are the text phrases input by the user, with the key word table.

Next, a key word most similar to the extracted core key words is extracted by comparing similarities between the key word table and the extracted core key words (operation 625).

For example, “recommended good restaurant” and “restaurant” corresponding to key words most similar to the core key word “good restaurant” are extracted from the key word table.

Next, the key words are accumulated during a specific time that is input by a user (operation 630). For example, “University Road” and “movie theater” as well as “recommended good restaurant” and “restaurant” are added to the key words.

Next, advertisement information that is matched with the accumulated key words is requested from the server 120 (operation 635). For example, an advertisement that is matched with “recommended good restaurant”, “restaurant”, “University Road”, and “movie theater”, which are the accumulated key words, is requested from the server 120.

In another exemplary embodiment, when the terminal 110 requests the server 120 to send an advertisement that is matched with the accumulated key words, the terminal 110 may transmit current location information of a user, which is searched for by using the global positioning system (GPS), together with a request for the advertisement to the server 120.

Next, it is checked whether the advertisement, which is matched with the accumulated key words, exists in the server 120, based on the request for the advertisement, which is received by the server 120 (operation 640).

Next, if the advertisement, which is matched with the accumulated key words, exists in the server 120 (operation 640—YES), the advertisement is received from the server 120 (operation 645). If the advertisement, which is matched with the accumulated key words does not exist in the server 120 (operation 640—No), the process ends.

Next, the received advertisement is provided in the upper portion of the touch keypad (operation 650). For example, as illustrated in FIG. 7, the terminal 110 displays “Gimbap Chungook” and “One Halmoney”, which are advertisement information matched with “recommended good restaurant”, “restaurant”, and “University Road” that are the key words of a user, on an advertisement display area 710. In addition, as illustrated in FIG. 7, the terminal 110 may intuitively display more detailed advertisement information to a user by additionally displaying an arrow and a distance in the advertisement display area 710.

In addition, a user may right or left scroll an advertisement list displayed in the advertisement display area 710 by using a scroll key of a scroll control area 720 to see the advertisement list.

Thus, since the advertisement is provided in an upper portion of a virtual keypad area of a user, it does not interfere with a user's operations. In addition, the advertisement may be provided in various circumstances such as when sending an email or letters and chatting, in addition to web-browsing.

In this case, it is checked whether a click signal for the provided advertisement is received from a user (operation 655).

Next, if the click signal for the provided advertisement is received from a user (operation 655—Yes), detailed information related to the provided advertisement appears (operation 660). If the click signal for the provided advertisement is not received from a user (operation 655—No), the process ends. The detailed information may include a webpage, an email, etc.

Consequently, the terminal 110 according to the above exemplary embodiments, may display in real time an advertisement based on a tendency of a user by collecting the tendency of the user in real time. In addition, a user may obtain advertisement information similar to that which a user intended to obtain, without performing an information search.

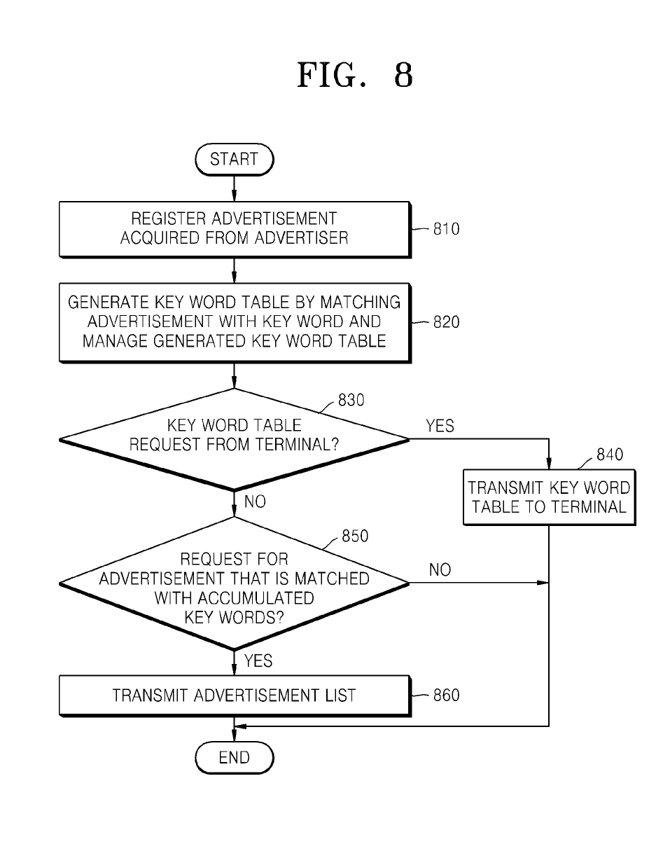

FIG. 8 is a flowchart illustrating a method of providing an advertisement from a server, according to an exemplary embodiment.

First, an advertisement is acquired from an advertiser.

Next, the advertisement acquired from the advertiser is registered (operation 810).

Next, a key word table is generated by matching the registered advertisement with a specific key word, and the generated key word table is managed (operation 820). In this case, the key word table stores advertisement data classified according to conditions that are desired by advertisers.

Next, it is checked whether the key word table is requested by the terminal 110 (operation 830).

Next, if the key word table is requested by the terminal 110 (operation 830—Yes), the key word table is transmitted to the terminal 110.

Next, if the key word table is not requested by the terminal 110 (operation 830—No), it is checked whether an advertisement that is matched with accumulated key words is requested by the terminal 110 (operation 850).

Next, if an advertisement that is matched with the accumulated key words is requested by the terminal 110 (operation 850—Yes), similar advertisement lists are searched in an advertisement table, and then a corresponding advertisement list is transmitted to the terminal 110 (operation 860). If an advertisement that is matched with the accumulated key words is not requested by the terminal 110 (operation 850—No), the process ends.

In another exemplary embodiment, the server 120 may match advertisement information of a company, which is closest to a location of a user, with accumulated key words by using current location information of the user, which is received from the terminal 110.

The above-described exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc.

While the inventive concept has been particularly shown and described with reference to exemplary embodiments thereof, it will be understood by those of ordinary skill in the art that various changes in form and details may be made therein without departing from the spirit and scope of the present invention as defined by the following claims. Accordingly, the disclosed exemplary embodiments should be considered in an illustrative sense rather than a limiting sense. The scope of the exemplary embodiments is defined not by the detailed description of the exemplary embodiments but by the appended claims, and all differences within the scope will be construed as being included in the present invention.

What is claimed is:

1. A method of providing an advertisement in a terminal, the method comprising:
extracting a key word from input content based on a predetermined key word table;
obtaining an advertisement corresponding to the extracted key word, from a server by using the extracted key word; and
providing the advertisement obtained from the server in a predetermined portion of a keypad input area of a screen of the terminal.

2. The method of claim 1, further comprising:
if the advertisement provided in the predetermined portion of the keypad input area is selected, providing detailed information related to the advertisement.

3. The method of claim 1, further comprising:
obtaining the predetermined key word table from the server by requesting the server to send the predetermined key word table.

4. The method of claim 1, wherein the predetermined key word table is generated by matching a registered advertisement with a specific key word in the server.

5. The method of claim 1, wherein the key word is extracted by comparing the predetermined key word table, which is obtained from the server, with input content.

6. The method of claim 1, wherein the obtaining of the advertisement comprises:
extracting key words similar to a core key word extracted based on the predetermined key word table;
accumulating the extracted key words;
requesting the server to send an advertisement that corresponds to the accumulated key words; and
receiving the advertisement corresponding to the accumulated key words from the server.

7. The method of claim 6, wherein current location information of the terminal as well as a request for the advertisement corresponding to the accumulated key words is transmitted to the server.

8. The method of claim 1, wherein the key word is extracted based on content that is input during a predetermined time by a user.

9. The method of claim 1, wherein the predetermined portion of the key input area comprises an upper portion of the keypad input area.

10. The method of claim 1, wherein the providing of the advertisement comprises:
checking whether an advertisement corresponding to accumulated key words, exists; and
if the advertisement, which corresponds to the accumulated key words, exists, providing the advertisement in the predetermined portion of the keypad area.

11. The method of claim 1, wherein the providing of the advertisement comprises providing detailed information related to the provided advertisement if a click signal for the provided advertisement is received.

12. The method of claim 1, wherein, in the providing of the advertisement, an advertisement list displayed in an upper portion of a touch keypad is scrollable.

13. The method of claim 1, wherein the server registers an advertisement received from an advertiser, generates a key word table by matching the advertisement with a predetermined key word, transmits the key word table to the terminal according to the terminal's request for the key word table, and transmits a corresponding advertisement to the terminal if a request for an advertisement that corresponds to accumulated key words is received from the terminal.

14. The method of claim 13, wherein a current location and advertisement information are matched with each other if the current location is received from the terminal.

15. A terminal comprising:
an input device which receives input from a user;
a display which displays a touch keypad and an advertisement;
a controller which extracts a key word by comparing the input from the user with a predetermined key word table, receives an advertisement, which corresponds to the extracted key word, from the server, and provides the advertisement, corresponding to the extracted key word, in a portion of a touch keypad of the display.

16. The terminal of claim 15, wherein the display comprises a touch keypad area and an advertisement display area, and the advertisement display area is displayed in the upper portion of the touch keypad area.

17. A computer readable recording medium having recorded thereon a program for executing the method of claim 1.

18. A method of providing an advertisement in a terminal, the method comprising:
extracting a key word from user input; and
displaying an advertisement corresponding to the extracted key word in a predetermined portion of a keypad input area.

19. The method of claim 18, wherein the advertisement is obtained using a predetermined key word table.
